(19) United States
(12) Patent Application Publication
(10) Pub. No.: US 2018/0302368 A1
(43) Pub. Date: Oct. 18, 2018

(54) TELEPHONE NUMBER PROVISIONING USING LOCATION-BASED PARTITION KEYS

(71) Applicant: Microsoft Technology Licensing, LLC, Redmond, WA (US)

(72) Inventors: Helbert Fonseca Maich, Vancouver (CA); Piotr Witkowski, Redmond, WA (US)

(21) Appl. No.: 15/486,535

(22) Filed: Apr. 13, 2017

(51) Int. Cl. H04L 29/12; G06F 17/30

(52) U.S. Cl. CPC H04L 61/20; G06F 17/30486; H04Q 2213/13097; G06F 17/30321; H04L 61/605; G06F 17/30339

(57) ABSTRACT

Systems, methods, and software technology for provisioning end-points in a communication service with geographically relevant telephone numbers drawn from a data table that may be searched using partition keys derived from identifying characteristics of a location. In an implementation, the telephone numbers in the data table may be associated with partition keys related to their location. Then, when requests are received for available numbers in a particular location, the data table may be queried using the partition key associated with that location.

### TECHNICAL BACKGROUND

A key/value database is a type of data storage paradigm for storing records in association with keys. Such a database may be implemented in a table that is defined by its columns and rows of data. Data in a particular row may be accessed by searching for a row key and then navigating to the data in the row. Searching such data tables can be fast when the key is known, but can be very slow when the key is not known.

Data tables can be partitioned, which may speed-up queries when a key is not known as the queries can be executed against each partition in parallel. Even then, parallel searches of the same partition may overlap or otherwise interfere with each other. In some cases, the speed of a search can be increased further by intelligently organizing the partitions and then selectively identifying which partition to search.

In an example related to telephone numbers, a data table created under the key/value paradigm may include a list of available telephone numbers. The data table may be partitioned based on the area code in each number, such that a search for an available number with a particular area code may be directed to a particular partition. The search may thus return numbers from that partition, without having to search other partitions.

While fast relative to having to search the other partitions, the telephone numbers returned by the search discussed above will all have the same area code by virtue of residing in a partition specific to that area code. However, many regions are served by multiple area codes—especially more densely populated cities and states. Thus, to find available numbers in a region served by multiple area codes, multiple searches of multiple partitions may be needed, thereby increasing the complexity and duration of the task.

### OVERVIEW

Technology is disclosed herein for provisioning end-points in a communication service with geographically relevant telephone numbers drawn from a data table that may be searched using partition keys derived from identifying characteristics of a location. In an implementation, the telephone numbers in the data table may be associated with partition keys related to their location. Then, when requests are received for available numbers in a particular location, the data table may be queried using the partition key associated with that location.

In this manner, telephone numbers may be associated with particular locations, so that availability searches may be performed without regard to specific area codes. In some implementations, multiple queries with the same partition key—but different row keys—may be performed against the data table, further increasing the speed of a search. The row keys may identify sub-partitions of the partition associated with the partition key, for example, such that each query is directed to a different sub-partition in parallel with the others.

This Overview is provided to introduce a selection of concepts in a simplified form that are further described below in the Technical Disclosure. It may be understood that this Overview is not intended to identify key features or essential features of the claimed subject matter, nor is it intended to be used to limit the scope of the claimed subject matter.

### BRIEF DESCRIPTION OF THE DRAWINGS

Many aspects of the disclosure can be better understood with reference to the following drawings. While several implementations are described in connection with these drawings, the disclosure is not limited to the implementations disclosed herein. On the contrary, the intent is to cover all alternatives, modifications, and equivalents.

FIG. 1A illustrates an operational environment in an implementation of enhanced telephone number provisioning using location-based partition keys.

FIG. 1B illustrates a detailed view of a data table in an implementation.

FIG. 2 illustrates a provisioning process in an implementation.

FIGS. 3A-3B illustrate an operational scenario in an implementation.

FIG. 4A illustrates another operational environment in an implementation.

FIG. 4B illustrates a detailed view of another data table in an implementation.

FIG. 5 illustrates a provisioning process in an implementation.

FIGS. 6A-6B illustrate an operational scenario in an implementation.

FIG. 7 illustrates another operational environment in an implementation.

FIG. 8 illustrates a search process in an implementation.

FIG. 9 illustrates a computing system suitable for implementing the number provisioning technology disclosed herein, including any of the architectures, environments, elements, processes, and operational scenarios and sequences illustrated in the Figures and discussed below in the Technical Disclosure.

### TECHNICAL DISCLOSURE

Technology is disclosed herein for storing telephone numbers in a data table and provisioning the telephone numbers for use in a communication service. The telephone numbers may be entered in the table in association with geo-coded partition keys such that the table may be partitioned or “sharded” for faster searching. In some implementations, the table may be further partitioned into sub-partitions or “sub shards.”

The communication service may then query the table for available phone numbers using a partition key related to a particular geographic location, such as a city, state, region, or country. A query service searches the table using at least the partition key to find available phone numbers, which may then be assigned to end-points in the communication service. Utilizing the partition key speeds-up the search as only the partition associated with the key need be searched for available numbers.

The query service may perform multiple searches of a given partition in parallel to increase the speed of the search still more. In implementations where sub-partitioning is employed, the parallel searches may employ different combinations of the partition key and row keys. Such a technique allows rows in different sub-partitions of the table to be examined at the same time, without any overlap in rows. However, parallel searches may still be executed in scenarios that lack any sub-partitioning using techniques such as randomized row selection to reduce the likelihood of overlapping searches.

At least some of the telephone numbers returned by the query service to the communication service may be assigned to end-points, regardless of the whether the end-points actually reside in the specified location. Rather, the telephone numbers themselves may connote some geographic significance, such as by their area code, country code, or other such numeric characteristic, that is desired by a customer for various reasons.

In some cases, more than one telephone number may be assigned to a single end-point, thereby giving the end-point flexibility in terms of how the location of the end-point is represented when placing or receiving calls. The multiple numbers may be associated with the same location, but in some scenarios the multiple numbers may be associated with different locations. For example, a single end-point may be assigned a number associated with one city, and then a second number associated with a different city. The two numbers may be obtained by admin personnel by making two different telephone number requests: one made with respect to the first city, and then a second request made with respect to the second city.

In another illustrative example, a given partition may have hundreds or even thousands of available telephone numbers and thirty or more sub-partitions in a table of hundreds of thousands, millions, or even more telephone numbers. A communication service could submit thirty or more queries that each differ relative to each other due to their unique partition key/row key combinations. The query service could then execute parallel searches against each sub-partition, meaning that one row in each sub-partition is searched at a time—while one row in each other sub-partition is searched at the same time. Thirty available telephone numbers from different sub-partitions could be returned to the communication service almost immediately.

If the communication service were to instead submit thirty of the exact same query to the query service, it would be possible—and even likely—that two or more of the queries would be executed against the same row. Not only would this be wasteful, but such simultaneous access could to lead to corrupted data or other operational detractions. In contrast, the aspects disclosed herein have the technical effect of ensuring that parallel searches can be executed against a telephone number table without the searches colliding.

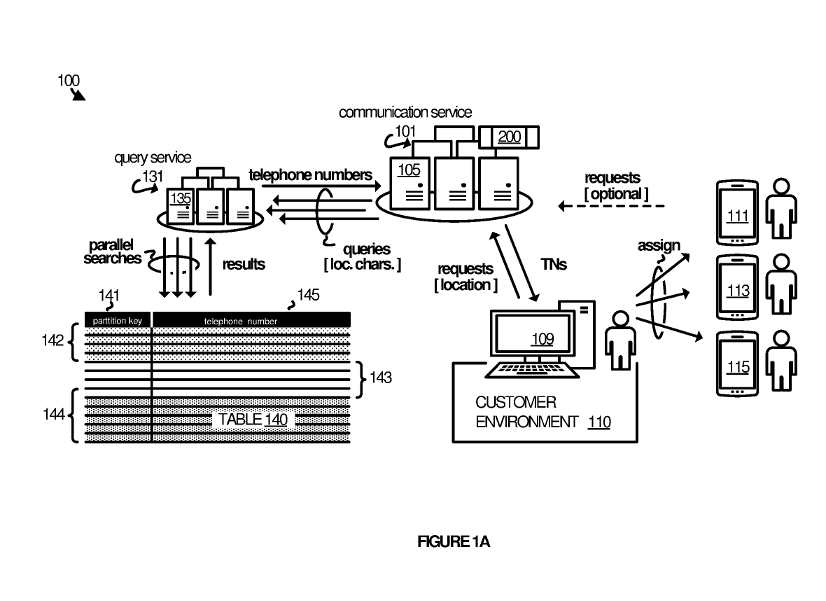

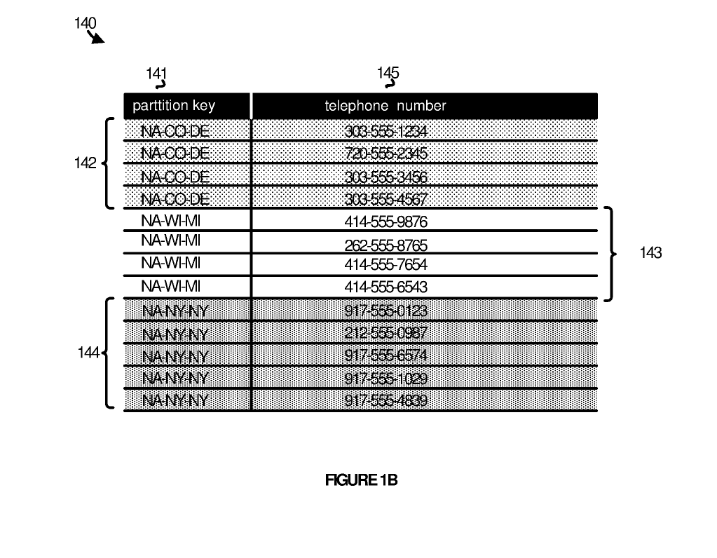

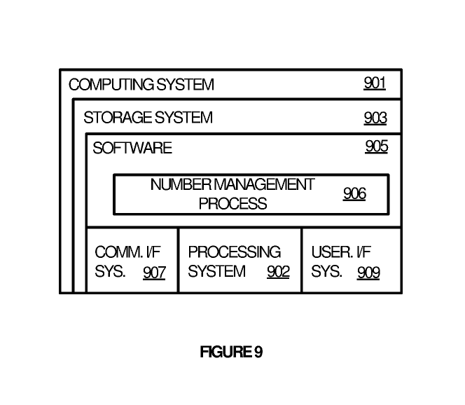

FIG. 1A illustrates an operational environment 100 in an implementation to further describe various technical aspects. Operational environment 100 includes a communication service 101 that provides telephony capabilities to businesses, organizations, end-users, or other such entities. Communication service 101 may be implemented as a stand-alone telephony service or it may be integrated with other services of any type. Communication service 101 may be implemented in one or more data centers (physical or virtual), represented by data center 105, and on one or more computing systems, of which computing system 900 in FIG. 9 is representative.

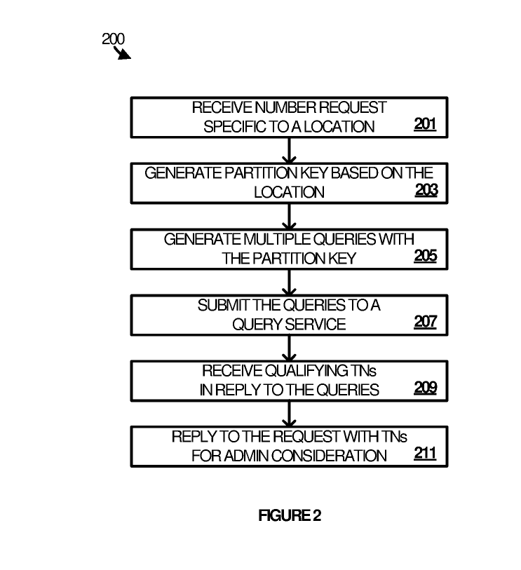

At least one capability provided by communication service 101 includes acquiring, managing, and allocating telephone numbers to customers and their end-points. The telephone numbers may then be used by others to reach a given end-point assigned to a particular phone number. Communication service 101 provisions telephone numbers in accordance with provisioning process 200, illustrated with respect to FIG. 2.

Provisioning process 200 may be employed in the context of servicing customer requests for telephone numbers. Provisioning process 200 may be implemented in program instructions in the context of any of the software applications, modules, components, or other such programming elements that comprise communication service 101. The program instructions direct the underlying physical or virtual computing system or systems that provide the communication service to operate as follows.

Customers may initiate such requests through customer service web sites, administrative portals, mobile applications, or any other software suitable for interfacing with communication service 101. Such software may be experienced locally by the customer on any local computing device, such as a desktop computer, laptop, tablet, or mobile phone, of which computing device 109 in customer environment 110 is representative. The web site, portal, or other similar access point may itself be hosted in communication service 101 or in some other, intermediary service.

In this example environment, administrative personnel interface with communication service 101 through computing device 109 to initiate requests for telephone numbers to be assigned to end-points 111, 113, and 115, although it may be appreciated that requests could optionally come from the end-points themselves. End-points 111, 113, and 115 are representative of any communication hardware device, software application, or combination thereof capable of being reached by a telephone number. Examples include, but are not limited to, mobile phones, tablets, laptops, and desktop computers, as well as voice and/or video telephony applications, messaging applications, and other suitable clients. Some specific examples include Skype® and Skype for Business® from Microsoft®.

The telephone numbers managed by communication service 101 reside in a table 140 accessible via a query service 131. Query service 131 may itself be implemented in one or more data centers (physical or virtual), represented by data center 135, and on one or more computing systems, of which computing system 900 in FIG. 9 is representative. Data center 135 and data center 105 could be combined or co-located in some implementations.

Table 140 is defined in terms of columns and rows. Column 141 holds the partition key for each row, while column 145 holds the telephone number stored in each row. Table 140 may thus be considered to be partitioned by partition keys. For example, partition 142 includes a set of rows having the same partition key, while partition 143 and partition 144 each include a set of rows having different partition keys relative to partition 142 and relative to each other. FIG. 1B illustrates table 140 in more detail where exemplary partition keys are shown for each partition, as well as different phone numbers for each row.

As may be appreciated from FIG. 1B, the partition keys in column 141 of table 140 are geo-coded such that they are at least somewhat representative of a particular geographic area. For example, the keys in partition 142 are geo-coded as “NA-CO-DE,” which represents their associated phone numbers as belonging to the North American region in the State of Colorado and the City of Denver. In contrast, the keys in partition 143 are geo-coded as “NA-WI-MI,” which represents their associated phone numbers as belonging to the North American region in the State of Wisconsin and the City of Milwaukee. Lastly, the keys in partition 144 are geo-coded as NA-NY-NY, meaning their associated phone numbers belong to the North American region in the State of New York and the City of New York. Indeed, the “303” and “720” area codes in the North American Numbering Plan, in the NPX-NXX-XXXX number format, are generally associated with Denver, while “414” and “262’ are associated with Milwaukee, and “917” and “212” with New York City. (While the numbering examples provided herein refer to the North American Dialing Plan format, it may be appreciated that may other formats associated with any other regions around the world may be used and are considered within the scope of the present disclosure.)

In operation, a customer of communication service 101 may wish to obtain telephone numbers to assign to new or existing end-points in an organization. In addition, the customer may wish to obtain phone numbers that have an association with a specific geographic area (e.g. Denver, Milwaukee, or New York), regardless of whether an end-point(s) would actually reside in or be physically present in the area.

To advance the goal, the customer submits a location-specific request to communication service 101 for one or more telephone numbers. An end-user at customer environment 110, interfacing with a web site or other such portal via computing device 109, may select or otherwise specify a preferred geographic area. The location is included in the request that is submitted to communication service 101.

Referring parenthetically to the steps illustrated in FIG. 2, communication service 101 receives the request(s) (step 201) and responsively generates a partition key based on the location identified in the request (step 203). For example, a request that specifies “Denver” as a desired location may cause communication service 101 to generate a partition key with the geo-code “NA-CO-DE,” while a request that specifies New York City may result in a partition key of “NA-NY-NY.”

Communication service 101 may generate the partition keys by accessing a look-up table that stores pre-defined partition keys in association with particular geographic areas. In other implementations, communication service 101 may execute a programmatic script on a per-location bases that defines key-to-region relationships. Other techniques may also be possible for generating partition keys which may be considered within the scope of the present disclosure.

With the partition key in-hand communication service 101 generates multiple queries, each with the same partition key (step 205). In some cases, the partition key is the only key in each query. However, in other cases other keys are used in addition to the partition key. For example, one or more row keys could be used in each query to distinguish the queries from each other. The row keys could be randomly or pseudo-randomly generated, but may also be programmatically determined.

Communication service 101 then submits the multiple queries to query service 131 for parallel execution against table 140 (step 207). The queries themselves may be submitted in parallel (at the same time) or substantially in parallel.

Query service 131 receives the queries and responsively searches the partition specified in each query for a telephone number or numbers that satisfies the queries. This may involve reading the telephone number from each row and returning the qualifying telephone numbers to communication service 101.

Communication service 101 receives the qualifying numbers from query service 131 (step 209) and replies to the initial customer request with a list of numbers to consider (step 211). In some implementations, communication service 101 instructs query service 131 to pause after a certain quantity of numbers have been returned to give the customer time to consider them and to avoid retrieving an unnecessary quantity of numbers.

The admin personnel on the customer-side may select one or more of the available telephone numbers to assign to one or more of end-points 111, 113, and 115. The numbers may be assigned on a 1:1 basis, but in some cases multiple telephone numbers may be assigned to a single end-point. Communication service 101 populates its routing tables with the new associations so that incoming phone calls to the selected telephone numbers may be routed to the appropriate end-points.

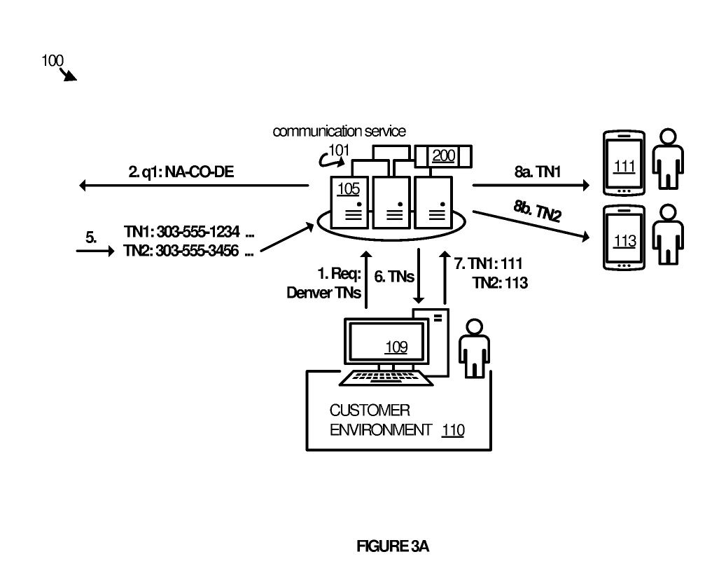

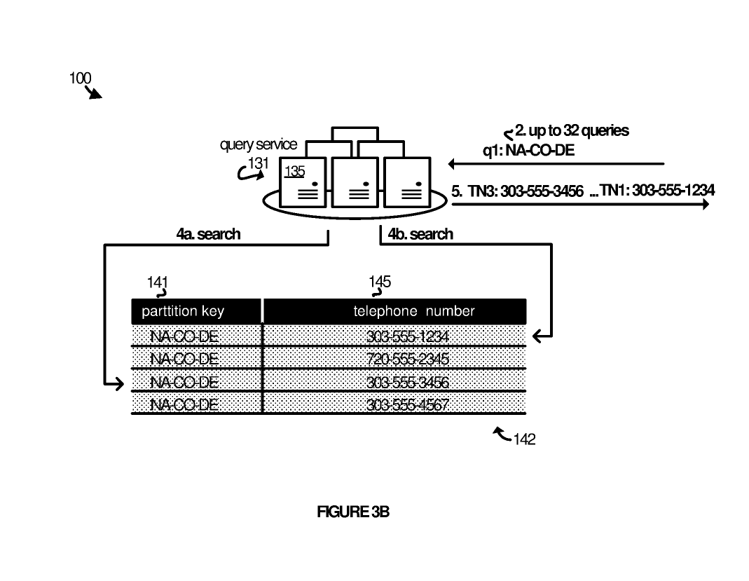

FIG. 3A illustrates an exemplary operational scenario with respect to operational environment 100 that continues to FIG. 3B. In FIG. 3A, the scenario begins with a user in customer environment 110 submitting request for telephone numbers from computing system 109. The request identifies “Denver” as the desired location associated with the request. The location may be specified in a string that spells out the name of the location, in an abbreviation, in an encoded manner, or by some other mechanism.

Communication service 101 receives the request and generates a partition code based on identifying characteristics of the location. The identifying characteristics may include, for example, a name of a city, a state within which the city resides, and a region that surrounds the city. In this example, the name of the location resolves to a partition code of “NA-CO-DE.” Accordingly, communication service 101 submits multiple queries to query service 131 that each include the partition code.

Referring to FIG. 3B, query service 131 receives the queries and responsively enters into partition 142 of table 140, which is identified by the partition key in the queries. Query service 131 begins to read telephone numbers from the table and returns them to communication service 101. For example, two telephone numbers from the first and third rows in table 140 are extracted and sent to communication service 101.

Returning to FIG. 3A, communication service 101 receives the telephone numbers and provides them to the customer for their consideration. In some cases, communication service 101 may perform some filtering on numbers that are returned by query service 131. For instance, the numbers may be filtered based on their area code (NPA), central office code (NXX), or the last four digits of a number (XXXX).

The customer may then decide which numbers to use and how to use them. In this example, the first telephone number provided by communication service 101 is assigned to end-point 111, while the second number is assigned to end-point 113. From that point forward, phone calls may be placed to each of telephone numbers in order to reach the corresponding end-point.

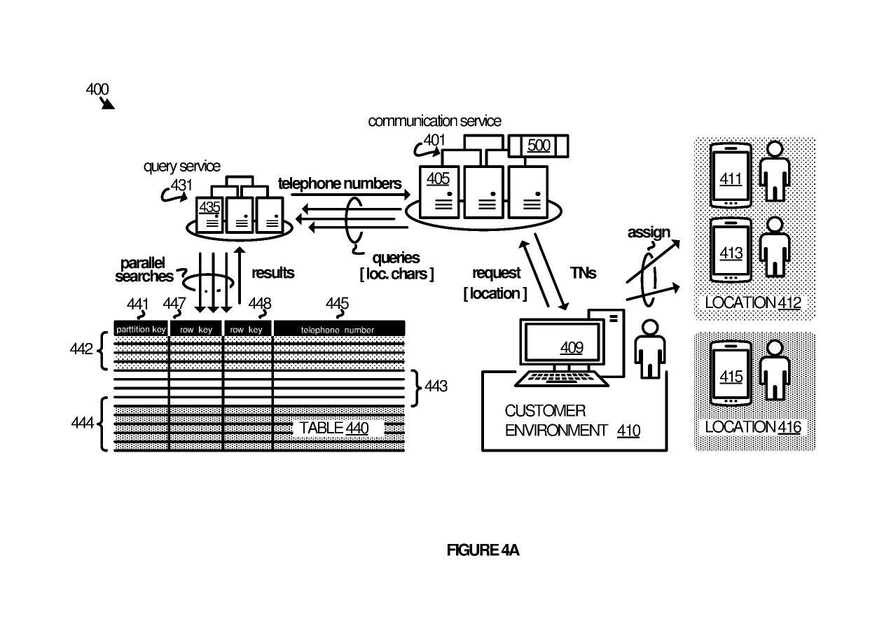

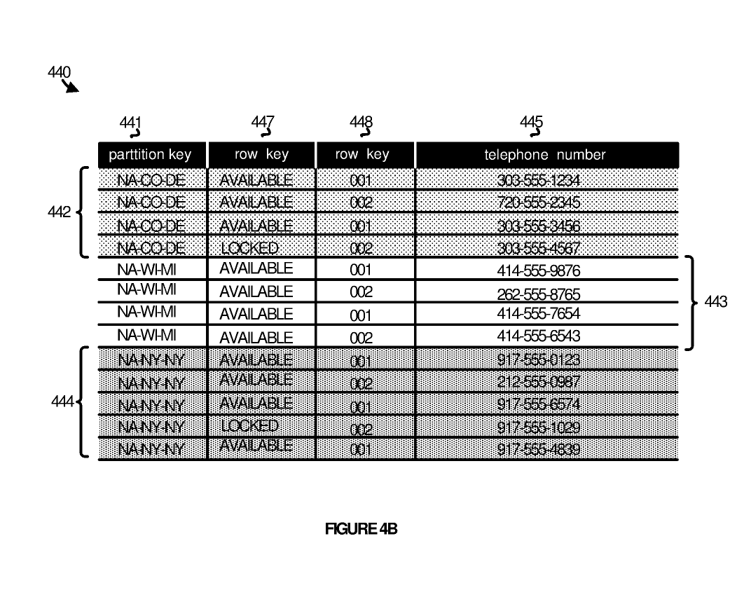

FIG. 4A illustrates another operational environment in an implementation. Operational environment 400 includes communication service 401, which may be hosted in data center 405. Communication service 401 provides telephony capabilities to businesses, organizations, end-users, or other such entities, either as a stand-alone telephony service or possibly integrated with other services. Communication service 401 may be implemented in one or more data centers (physical or virtual), represented by data center 405, and on one or more computing systems, of which computing system 900 in FIG. 9 is representative.

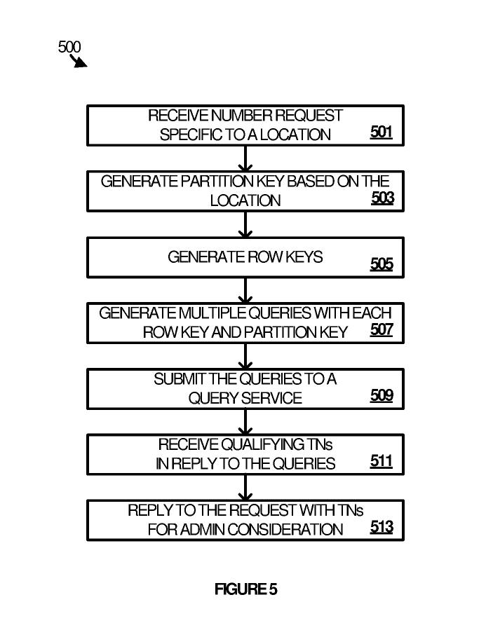

Communication service 401 is representative of any service capable of acquiring, managing, and allocating telephone numbers to customers and their end-points. The telephone numbers may then be used by others to reach a given end-point assigned to a particular phone number. Communication service 401 provisions telephone numbers in accordance with provisioning process 500, illustrated with respect to FIG. 5.

Provisioning process 500 may be employed in the context of servicing customer requests for telephone numbers. Provisioning process 500 may be implemented in program instructions in the context of any of the software applications, modules, components, or other such programming elements that comprise communication service 401. The program instructions direct the underlying physical or virtual computing system or systems that provide the communication service to operate as follows.

Customers may initiate such requests through customer service web sites, administrative portals, mobile applications, or any other software suitable for interfacing with communication service 401. Such software may be experience locally by the customer on any local computing device, such as a desktop computer, laptop, tablet, or mobile phone, of which computing device 409 in customer environment 410 is representative. The web site, portal, or other similar access point may itself be hosted in communication service 401 or in some other service.

Administrative personnel may interface with communication service 401 through computing device 409 to initiate requests for telephone numbers to be assigned to end-points 411, 413, and 415, although it may be appreciated that requests could optionally come from the end-points themselves. End-points 411, 413, and 415 are representative of any communication hardware device, software application, or combination thereof capable of being reached by a telephone number. End-points 411 and 413 are associated with location 412 in this example, while end-point 415 is associated with location 416.

The telephone numbers managed by communication service 401 reside in table 440, which may be accessed via a query service 431. Query service 431 may also be implemented in one or more data centers (physical or virtual), represented by data center 435, and on one or more computing systems, of which computing system 900 in FIG. 9 is representative. Data center 435 and data center 405 could be combined or co-located in some implementations.

Table 440 is defined in terms of columns and rows. Column 441 holds the partition key for each row, while column 445 holds the telephone number stored in each row. Table 440 may thus be considered to be partitioned by partition key. For example, partition 442 includes a set of rows having the same partition key, while partition 443 and partition 444 each include a set of rows having different partition keys relative to partition 442 and relative to each other. Partition 442 has a shade similar to that of location 412 to represent that its partition key relates to location 412. Likewise, partition 444 is shaded the same as location 416 to represent that its partition key relates to location 416.

Table 440 also includes column 447 and column 448. Column 447 holds row keys, while column 447 holds additional row keys. The first set of row keys function to sub-partition (or sub-shard) each partition, while the second set of row keys further-partitions the sub-partitions. Such sub-partitioning may further increase the speed with which telephone numbers may be identified in and retrieved from table 440.

FIG. 4B illustrates table 440 in more detail where exemplary partition keys are shown for each partition, as well as exemplary row keys for each column and different phone numbers for each row. The partition keys in column 441 of table 440 are geo-coded such that they are at least somewhat representative of a particular geographic area. For example, the keys in partition 442 are geo-coded as “NA-CO-DE,” the keys in partition 443 are geo-coded as “NA-WI-MI,” and the keys in partition 444 are geo-coded as NA-NY-NY.

With respect to the row keys in column 447, each key indicates a status of the telephone number in its row as either AVAILABLE or LOCKED, although other status types are possible and may be considered within the scope of the present disclosure. The row keys in column 448 are simply one of two number strings: “001” or “002.” The strings represent which sub-partition a corresponding telephone number belongs to within a given partition. While only two sub-partitions are shown in this example, up to 32 sub-partitions could be used, which corresponds to the number of parallel searches that can be performed on table 440. In other words, for a partition having 32 sub-partitions, thirty-two parallel searches may be performed on the partition without the searches overlapping each other.

In operation, a customer of communication service 401 may wish to obtain telephone numbers to assign to new or existing end-points in an organization that have an association with a specific geographic area (e.g. Denver, Milwaukee, or New York). To advance the goal, the customer submits a location-specific request to communication service 401 for one or more telephone numbers. An end-user at customer environment 410 may input a preferred geographic area. The location is then included in the request that is submitted to communication service 401.

Referring parenthetically to the steps illustrated in FIG. 5, communication service 401 receives the request (step 501) and responsively generates a partition key based on the location identified in the request (step 503). For example, a request that specifies “Denver” as a desired location may cause communication service 501 to generate a partition key with the geo-code “NA-CO-DE,” while a request that specifies New York City may result in a partition key of “NA-NY-NY.”

Next, communication service 401 generates or otherwise identifies row keys (step 505). The row keys may be stored in a table or list or may be programmatically created by scripts. In some example, a set of row keys may be specific to a particular location.

Having identified the partition key and row keys, communication service 401 generates multiple queries using combinations of the partition key and row keys (step 507). The queries are submitted to query service 431 (step 509) so that they can be executed in parallel against table 440. The queries themselves may be submitted in parallel (at the same time) or substantially in parallel.

Query service 431 receives the queries and responsively searches the partition and sub-partition(s) specified in each query for a telephone number or numbers that satisfies the queries. This may involve reading the telephone number from each row the sub-partitions and returning the qualifying telephone numbers to communication service 401.

Communication service 401 receives the qualifying numbers from query service 431 (step 511) and replies to the initial customer request with a list of numbers to consider (step 513). In some implementations, communication service 401 instructs query service 431 to pause after a certain quantity of numbers have been returned to give the customer time to consider them and to avoid retrieving an unnecessary quantity of numbers.

The admin personnel on the customer-side may select one or more of the available telephone numbers to assign to one or more of end-points 411, 413, and 15. The numbers may be assigned on a 1:1 basis, but in some cases multiple telephone numbers may be assigned to a single end-point. Communication service 401 populates its routing tables with the new associations so that incoming phone calls to the selected telephone numbers may be routed to the appropriate end-points.

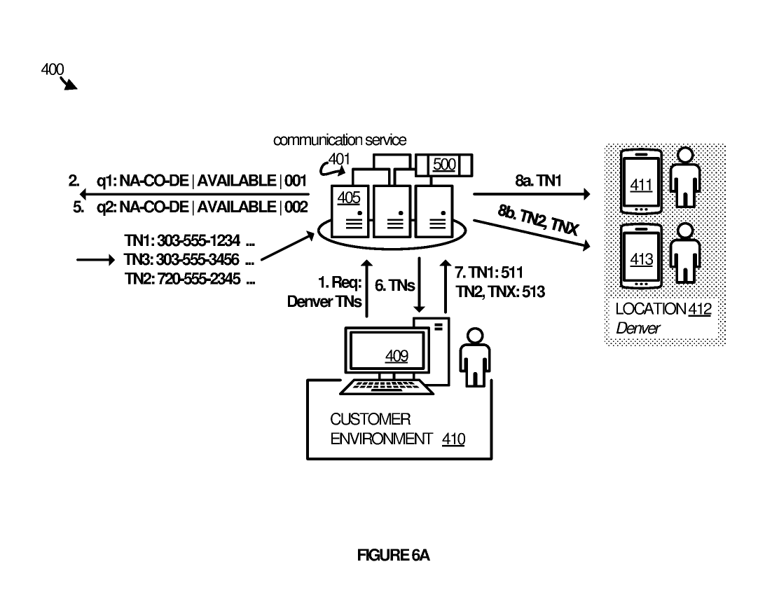

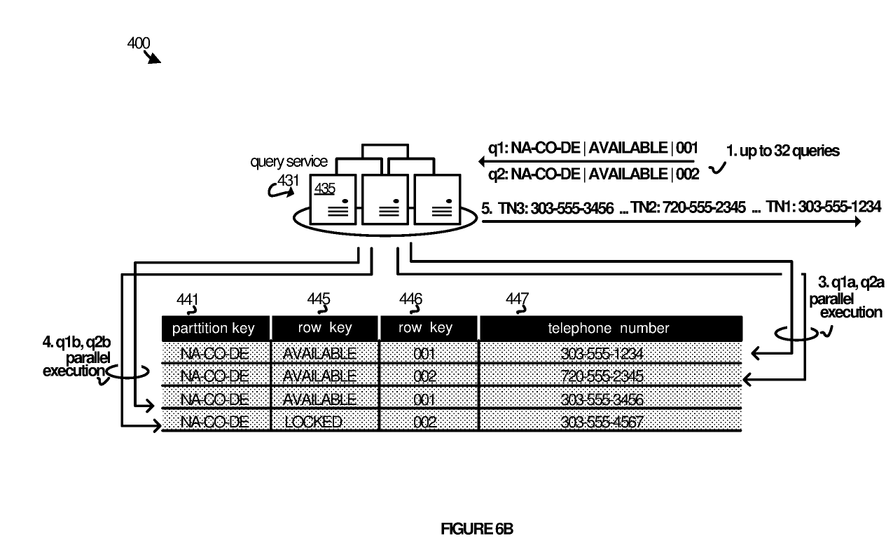

FIG. 6A illustrates an exemplary operational scenario with respect to operational environment 400 that continues to FIG. 6B. In FIG. 6A, the scenario begins with a user in customer environment 610 submitting request for Denver telephone numbers from computing system 409. Communication service 401 receives the request and generates a partition code based on identifying characteristics of the location. Communication service 401 also identifies row keys to combine with the partition code when submitting queries to query service 431.

In this example, the partition code is resolved to “NA-CO-DE,” while the first row keys “AVAILABLE” is identified along with row key “001” and row key “002.” Communication service 401 combines the keys into two queries. By the row key “001,” the first query directs query service 431 to look in the first sub-partition of partition 442 for available telephone numbers. By the row key “002,” the second query directs query service 431 to look in the second sub-partition of partition 442 for available phone numbers.

Query service 431 receives the queries (up to thirty-two of them, or as many as there may be sub-partitions) and implicitly ignores partition 443 and partition 444. Rather, query service 431 launches parallel searches of different sub-partitions to quickly find available phone numbers. Thus, the first and second rows in partition 442 are examined first (and in parallel), followed by the third and fourth rows. The first three numbers in the table all have row key values equal to “available,” and are therefore returned to communication service 401. The last number is “locked,” and so is not returned.

In another illustrative example, communication service 401 could submit thirty or more queries that each differ relative to each other due to their unique partition key/row key combinations. Query service 431 could then execute parallel searches against each sub-partition, meaning that one row in each sub-partition is searched at a time—while one row in each other sub-partition is searched at the same time. Thirty available telephone numbers from different sub-partitions could be returned to communication service 401 almost immediately. If communication service 401 were to instead submit thirty of the same query to query service 431, it would be possible that two or more of the queries would be executed against the same row. In contrast, submitting the differing queries ensures that parallel searches can be executed against table 440 without the searches colliding.

Communication service 401 receives the telephone numbers and provides them to the customer for their consideration. In some cases, communication service 401 may perform some filtering on numbers that are returned by query service 431, such as by area code, central office code, or the last four digits of a number.

The customer may then assign the telephone numbers to their end-points. Here, the first number is assigned to end-point 411, while end-point 413 is given two distinct numbers. The end-points are thus associated with location 412 (Denver), although their actual physical presence may be elsewhere outside of the location.

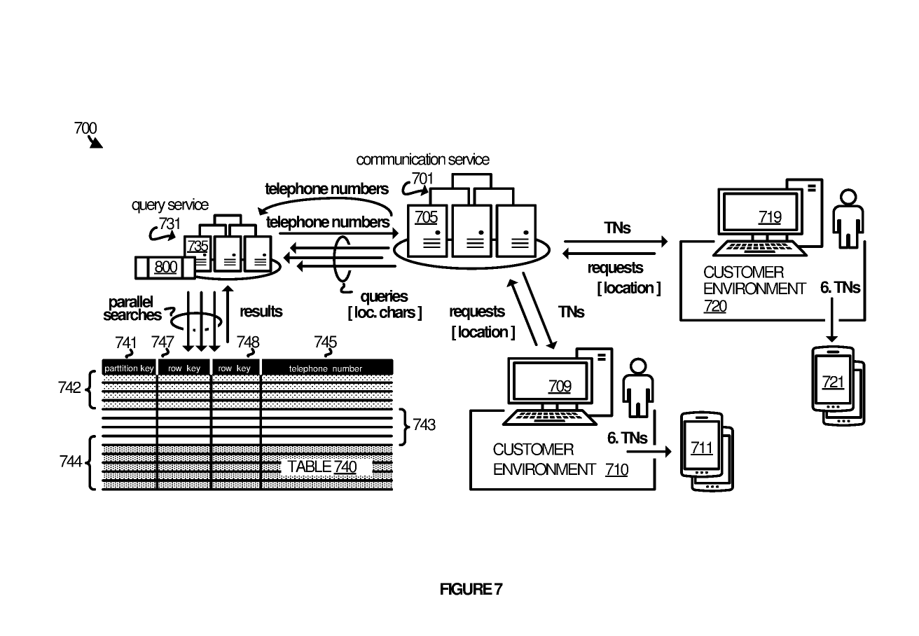

FIG. 7 illustrates operational environment 700 in another implementation. Operational environment 700 includes communication service 701, which may be hosted in data center 705. Communication service 701 provides telephony capabilities to businesses, organizations, end-users, or other such entities, either as a stand-alone telephony service or possibly integrated with other services. Communication service 701 may be implemented in one or more data centers (physical or virtual), represented by data center 705, and on one or more computing systems, of which computing system 900 in FIG. 9 is representative.

Communication service 701 is representative of any service capable of acquiring, managing, and allocating telephone numbers to customers and their end-points. The telephone numbers may then be used by others to reach a given end-point assigned to a particular phone number. Customers may initiate provisioning requests through customer service web sites, administrative portals, mobile applications, or any other software suitable for interfacing with communication service 701. Such software may be experience locally by the customer on any local computing device, such as a desktop computer, laptop, tablet, or mobile phone, of which computing device 709 in customer environment 710 and computing system 719 in customer environment 720 is representative.

Administrative personnel in both customer environment 710 and customer environment 720 may interface with communication service 701 through computing devices 709 and 719 respectively to initiate requests for telephone numbers to be assigned to end-points 711 and 721, although it may be appreciated that requests could optionally come from the end-points themselves. End-points 711 and 721 are representative of any communication hardware device, software application, or combination thereof capable of being reached by a telephone number. End-points 711 are associated with one customer in this example, while end-points 721 are associated with a different customer.

The telephone numbers managed by communication service 701 reside in table 740, which may be accessed via a query service 731. Query service 731 may also be implemented in one or more data centers (physical or virtual), represented by data center 735, and on one or more computing systems, of which computing system 900 in FIG. 9 is representative. Data center 735 and data center 705 could be combined or co-located in some implementations.

Table 740 is defined in terms of columns and rows. Column 741 holds the partition key for each row, while column 745 holds the telephone number stored in each row. Table 740 may thus be considered to be partitioned by partition key. For example, partition 742 includes a set of rows having the same partition key, while partition 743 and partition 744 each include a set of rows having different partition keys relative to partition 742 and relative to each other. Table 740 also includes column 747 and column 748. Column 747 holds row keys, while column 747 holds additional row keys. The first set of row keys function to sub-partition (or sub-shard) each partition, while the second set of row keys further-partitions the sub-partitions. Such sub-partitioning may further increase the speed with which telephone numbers may be identified in and retrieved from table 740.

In operation, the customers of communication service 701 may wish to obtain telephone numbers to assign to new or existing end-points in an organization that have an association with a specific geographic area (e.g. Denver, Milwaukee, or New York). To advance the goal, each customer submits a location-specific request to communication service 701 for one or more telephone numbers. Communication service 701 receives the requests and, for each request, responsively generates a partition key based on the location identified in the request.

Next, communication service 701 generates or otherwise identifies row keys. The row keys may be stored in a table or list or may be programmatically created by scripts. In some example, a set of row keys may be specific to a particular location.

Having identified the partition key and row keys, communication service 701 generates multiple queries for each request using combinations of the partition key and row keys. The queries are submitted to query service 731 so that they can be executed in parallel against table 740. The queries themselves may be submitted in parallel (at the same time) or substantially in parallel.

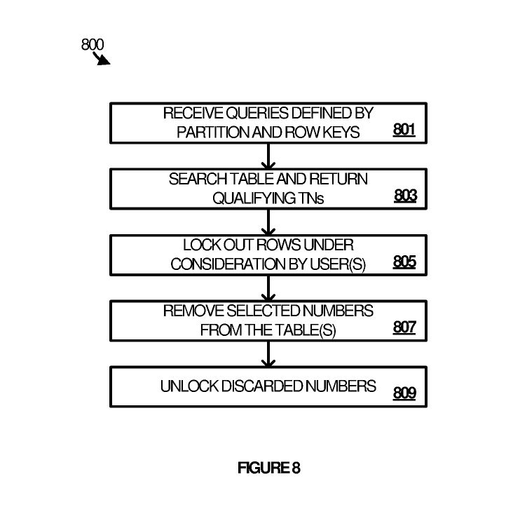

Query service 731 handles the queries in accordance with query process 800 illustrated with respect to FIG. 8. Query process 800 may be employed in the context of servicing number queries from communication service 701. Query process 500 may be implemented in program instructions in the context of any of the software applications, modules, components, or other such programming elements that comprise query service 731. The program instructions direct the underlying physical or virtual computing system or systems that provide the query service to operate as follows.

Query service 731 receives the queries from communication service 701 (step 801) and responsively searches the identified partitions and sub-partition for qualifying telephone numbers (step 803). For any given row in which a telephone number is found and returned to communication service 701, query service 731 locks out the row while the number is being considered by a customer (step 805). This prevents the same number being returned to a different customer for their consideration at the same time as the number is being considered by the first customer. The status of a number being considered may be changed from available to locked in some scenarios.

Next, a number that is selected by a customer to be assigned to an end-point is removed from table 740 (step 807). In some implementations, the status of the number as indicated by one of its row keys may be changed to allocated, assigned, or the like. This will prevent the number from being subsequently retrieved by other searches until it is removed from the table. The number may be removed completely (deleted) and stored instead in a different table that tracks allocated numbers, as opposed to available numbers.

Query service 731 can also unlock previously-locked numbers that have been discarded by customers (step 809). For example, a number that is temporarily locked while under consideration by a customer can be unlocked and returns to an available status once the customer has decided not to use the number. Communication service 701 may communicate such a status change to query service 731 in response to customer decisions.

As query service 731 finds and returns phone numbers, communication service 701 receives the qualifying numbers and replies to customer requests with lists of numbers to consider. In some implementations, communication service 701 instructs query service 731 to pause after a certain quantity of numbers have been returned to give the customer time to consider them and to avoid retrieving an unnecessary quantity of numbers.

The admin personnel on the customer-side may select one or more of the available telephone numbers to assign to one or more of end-points. Communication service 701 populates its routing tables with the new associations so that incoming phone calls to the selected telephone numbers may be routed to the appropriate end-points.

FIG. 9 illustrates computing system 901, which is representative of any system or collection of systems in which the various applications, services, scenarios, and processes disclosed herein may be implemented. Examples of computing system 901 include, but are not limited to, server computers, rack servers, web servers, cloud computing platforms, and data center equipment, as well as any other type of physical or virtual server machine, container, and any variation or combination thereof. Other examples may include smart phones, laptop computers, tablet computers, desktop computers, hybrid computers, gaming machines, virtual reality devices, smart televisions, smart watches and other wearable devices, as well as any variation or combination thereof.

Computing system 901 may be implemented as a single apparatus, system, or device or may be implemented in a distributed manner as multiple apparatuses, systems, or devices. Computing system 901 includes, but is not limited to, processing system 902, storage system 903, software 905, communication interface system 907, and user interface system 909. Processing system 902 is operatively coupled with storage system 903, communication interface system 907, and user interface system 909.

Processing system 902 loads and executes software 905 from storage system 903. Software 905 includes number management process 906, which is representative of the processes discussed with respect to the preceding FIGS. 1-8, including provisioning process 200, provisioning process 500, and query process 800. When executed by processing system 902 to manage telephone numbers, software 905 directs processing system 902 to operate as described herein for at least the various processes, operational scenarios, and sequences discussed in the foregoing implementations. Computing system 901 may optionally include additional devices, features, or functionality not discussed for purposes of brevity.

Referring still to FIG. 9, processing system 902 may comprise a micro-processor and other circuitry that retrieves and executes software 905 from storage system 903. Processing system 902 may be implemented within a single processing device, but may also be distributed across multiple processing devices or sub-systems that cooperate in executing program instructions. Examples of processing system 902 include general purpose central processing units, application specific processors, and logic devices, as well as any other type of processing device, combinations, or variations thereof.

Storage system 903 may comprise any computer readable storage media readable by processing system 902 and capable of storing software 905. Storage system 903 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or other suitable storage media, except for propagated signals. In no case is the computer readable storage media a propagated signal.

In addition to computer readable storage media, in some implementations storage system 903 may also include computer readable communication media over which at least some of software 905 may be communicated internally or externally. Storage system 903 may be implemented as a single storage device, but may also be implemented across multiple storage devices or sub-systems co-located or distributed relative to each other. Storage system 903 may comprise additional elements, such as a controller, capable of communicating with processing system 902 or possibly other systems.

Software 905 may be implemented in program instructions and among other functions may, when executed by processing system 902, direct processing system 902 to operate as described with respect to the various operational scenarios, sequences, and processes illustrated herein. For example, software 905 may include program instructions for implementing provisioning processes 200 and 500 and/or query process 800.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 905 may include additional processes, programs, or components, such as operating system software, virtual machine software, or other application software, in addition to or that include number management process 906. Software 905 may also comprise firmware or some other form of machine-readable processing instructions executable by processing system 902.

In general, software 905 may, when loaded into processing system 902 and executed, transform a suitable apparatus, system, or device (of which computing system 901 is representative) overall from a general-purpose computing system into a special-purpose computing system customized to manage telephone number provisioning. Indeed, encoding software 905 on storage system 903 may transform the physical structure of storage system 903. The specific transformation of the physical structure may depend on various factors in different implementations of this description. Examples of such factors may include, but are not limited to, the technology used to implement the storage media of storage system 903 and whether the computer-storage media are characterized as primary or secondary storage, as well as other factors.

For example, if the computer readable storage media are implemented as semiconductor-based memory, software 905 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 907 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

User interface system 909 is optional and may include a keyboard, a mouse, a voice input device, a touch input device for receiving a touch gesture from a user, a motion input device for detecting non-touch gestures and other motions by a user, and other comparable input devices and associated processing elements capable of receiving user input from a user. Output devices such as a display, speakers, haptic devices, and other types of output devices may also be included in user interface system 909. In some cases, the input and output devices may be combined in a single device, such as a display capable of displaying images and receiving touch gestures. The aforementioned user input and output devices are well known in the art and need not be discussed at length here.

User interface system 909 may also include associated user interface software executable by processing system 902 in support of the various user input and output devices discussed above. Separately or in conjunction with each other and other hardware and software elements, the user interface software and user interface devices may support a graphical user interface, a natural user interface, or any other type of user interface.

Communication between computing system 901 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses, computing backplanes, or any other type of network, combination of network, or variation thereof. The aforementioned communication networks and protocols are well known and need not be discussed at length here. However, some communication protocols that may be used include, but are not limited to, the Internet protocol (IP, IPv4, IPv6, etc.), the transfer control protocol (TCP), and the user datagram protocol (UDP), as well as any other suitable communication protocol, variation, or combination thereof.

In any of the aforementioned examples in which data, content, or any other type of information is exchanged, the exchange of information may occur in accordance with any of a variety of protocols, including FTP (file transfer protocol), HTTP (hypertext transfer protocol), REST (representational state transfer), WebSocket, DOM (Document Object Model), HTML (hypertext markup language), CSS (cascading style sheets), HTMLS, XML (extensible markup language), JavaScript, JSON (JavaScript Object Notation), and AJAX (Asynchronous JavaScript and XML), as well as any other suitable protocol, variation, or combination thereof.

The functional block diagrams, operational scenarios and sequences, and flow diagrams provided in the Figures are representative of exemplary systems, environments, and methodologies for performing novel aspects of the disclosure. While, for purposes of simplicity of explanation, methods included herein may be in the form of a functional diagram, operational scenario or sequence, or flow diagram, and may be described as a series of acts, it is to be understood and appreciated that the methods are not limited by the order of acts, as some acts may, in accordance therewith, occur in a different order and/or concurrently with other acts from that shown and described herein. For example, those skilled in the art will understand and appreciate that a method could alternatively be represented as a series of interrelated states or events, such as in a state diagram. Moreover, not all acts illustrated in a methodology may be required for a novel implementation.

The descriptions and figures included herein depict specific implementations to teach those skilled in the art how to make and use the best option. For the purpose of teaching inventive principles, some conventional aspects have been simplified or omitted. Those skilled in the art will appreciate variations from these implementations that fall within the scope of the invention. Those skilled in the art will also appreciate that the features described above can be combined in various ways to form multiple implementations. As a result, the invention is not limited to the specific implementations described above, but only by the claims and their equivalents.

1. A method of provisioning end-points in a communication service with geographically relevant telephone numbers from a data table, the method comprising:
receiving a request for telephone numbers to assign to the end-points;
generating a partition key with which to query for the telephone numbers based at least on identifying characteristics of a location associated with the set of end-points;
querying the data table for the telephone numbers using the partition key; and
assigning at least one of the telephone numbers to at least one of the end-points.

2. The method of claim 1 further comprising:
generating a plurality of row keys with which to query for the telephone numbers; and
generating a plurality of queries that each include at least the partition key and a row key of the plurality of row keys.

3. The method of claim 2 wherein querying the data table for the telephone numbers using the partition key comprises submitting the plurality of queries to a query service for parallel execution against a partition of the data table associated with the partition key and a plurality of sub-partitions of the data table associated with the plurality of row keys.

4. The method of claim 3 wherein the partition key in each of the plurality queries identifies the partition to the query service and wherein the row key in each of the plurality of queries identifies a different one of the plurality of sub-partitions to the query service relative to the row key in each other one of the plurality of queries.

5. The method of claim 4 wherein the data table comprises a plurality of partitions and wherein the partition associated with the partition key comprises the plurality of sub-partitions, wherein each of the plurality of queries includes the partition key and includes one row key that differs relative to the row key included in each other of the plurality of queries.

6. The method of claim 5 wherein the identifying characteristics of the location comprise a name of the location, a name of a region surrounding the location, and a name of a country for the location and the region.

7. The method of claim 6 wherein generating the partition key based at least on the identifying characteristics of the location comprises encoding the name of the location, the name of the region, and the name of the country in the partition key.

8. The method of claim 7 wherein generating the plurality of row keys comprises encoding an identity of a sub-partition in each of the plurality of row keys that differs relative to the identity of the sub-partition encoded in each other of the plurality of row keys.

9. The method of claim 1 wherein the data table comprises a plurality of available telephone numbers and wherein the method further comprises receiving results from the query service comprising the telephone numbers in the plurality of available telephone numbers returned by at least some of the plurality of queries.

10. An apparatus for provisioning end-points in a communication service with geographically relevant telephone numbers from a data table, the apparatus comprising:
one or more computer readable storage media;
a processing system operatively coupled with the one or more computer readable storage media; and
program instructions stored on the one or more computer readable storage media that, when executed by the processing system, direct the processing system to at least:
receive a request for telephone numbers to assign to the end-points;
generate a partition key with which to query for the telephone numbers based at least on identifying characteristics of a location associated with the set of end-points;
query the data table for the telephone numbers using the partition key; and
assign at least one of the telephone numbers to at least one of the end-points.

11. The apparatus of claim 10 wherein the program instructions further direct the processing system to generate a plurality of row keys with which to query for the telephone numbers and to generate a plurality of queries that each include at least the partition key and a row key of the plurality of row keys.

12. The apparatus of claim 11 wherein to query the data table for the telephone numbers using the partition key, the program instructions direct the processing system to submit the plurality of queries to a query service for parallel execution against a partition of the data table associated with the partition key and a plurality of sub-partitions of the data table associated with the plurality of row keys.

13. The apparatus of claim 12 wherein the partition key in each of the plurality queries identifies the partition to the query service and wherein the row key in each of the plurality of queries identifies a different one of the plurality of sub-partitions to the query service relative to the row key in each other one of the plurality of queries.

14. The apparatus of claim 13 wherein the data table comprises a plurality of partitions and wherein the partition associated with the partition key comprises the plurality of sub-partitions, wherein each of the plurality of queries includes the partition key and includes one row key that differs relative to the row key included in each other of the plurality of queries.

15. The apparatus of claim 14 wherein the identifying characteristics of the location comprise a name of the location, a name of a region surrounding the location, and a name of a country for the location and the region.

16. The apparatus of claim 15 wherein to generate the partition key based at least on the identifying characteristics of the location, the program instructions direct the processing system to encode the name of the location, the name of the region, and the name of the country in the partition key.

17. The apparatus of claim 16 wherein to generate the plurality of row keys the program instructions direct the processing system to encode an identity of a sub-partition in each of the plurality of row keys that differs relative to the identity of the sub-partition encoded in each other of the plurality of row keys.

18. The apparatus of claim 10 wherein the data table comprises a plurality of available telephone numbers and wherein the program instructions further direct the processing system to receive results from the query service comprising the telephone numbers in the plurality of available telephone numbers returned by at least some of the plurality of queries.

19. A method of provisioning end-points in a communication service with geographically relevant telephone numbers from a data table, the method comprising:
in a data storage service, partitioning the data table into partitions and sub-partitions of each of the partitions;
in a query service associated with the data storage service:
receiving queries from the communication service for available telephone numbers from the data table, wherein each of the queries identifies a partition key associated with one of the partitions and a row key associated with a different one of the sub-partitions relative to the row key included in each other of the queries;
retrieving the available phone numbers in parallel from the sub-partitions in the partition associated with the row key identified in each of the queries; and
replying to the queries with the available phone numbers.

20. The method of claim 19 further comprising, in the communication service:
generating the partition key based at least on identifying characteristics of a location associated with the set of end-points;
wherein the identifying characteristics of the location comprise a name of the location, a name of a region surrounding the location, and a name of a country for the location and the region.
